(19) United States
(12) Patent Application Publication
(10) Pub. No.: US 2005/0284956 A1
(43) Pub. Date: Dec. 29, 2005

(54) Universal sprinkler housing

(76) Inventor: Ryan J. Mast, Hudsonville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/877,016

(22) Filed: Jun. 25, 2004

(51) Int. Cl. B05B 15/10

(52) U.S. Cl. 239/288; 239/288.5; 239/201; 239/203; 239/204

(57) ABSTRACT

A universal sprinkler housing includes a base member threadingly engaged with an upper member so as to be adjustable, thereby allowing the housing to accommodate and protect a variety of sized underground type sprinkler head assemblies. The base further includes a plurality of arched feet which allow the base to be disposed directly over the supply pipes of the irrigation system and includes a plurality of fin-like protrusions disposed on an outer surface thereof to prevent the base from moving during adjustment.

### BACKGROUND OF THE INVENTION

The invention relates to irrigation and more particularly to an in-ground irrigation system.

Underground irrigation or sprinkler systems are typically comprised of a series or network of pipes which are buried below the ground. The pipes are connected to a water supply which is distributed through the pipes to a series of risers. The risers are in turn connected or attached to one or more sprinkler head assemblies. The risers and associated sprinkler head assemblies are connected to the piping network at intervals so as to provide an even distribution of water on the ground surface to which the sprinkler system is designed to irrigate. The sprinkler head assemblies are typically of the “pop-up” configuration, wherein during the absence of water pressure the sprinklers are maintained in a retracted configuration (below or at grade). Once water pressure is applied, the sprinkler heads will “pop up” or extend above the ground surface to provide distribution of water upon the ground surface.

A common problem with such irrigation systems is that the sprinkler head assembly can be damaged by impacts or collisions with lawn equipment, people, vehicles, and the like. Even if the sprinkler head assembly is not directly damaged, it is possible that the force of an impact may be transmitted to the riser, thereby damaging the connection between the water pipe and the sprinkler head assembly. Further, even if no damage occurs, the impact may render the sprinkler head out of adjustment, thereby requiring costly or time consuming service.

### SUMMARY OF THE INVENTION

In the present invention, a universal sprinkler housing is disclosed having a base member and an upper member threadingly engaged with each other so as to be adjustable. This adjustability creates a housing which can accommodate and protect various sizes of underground type sprinkler head assemblies.

In a preferred embodiment of the invention, the base is adapted to be disposed over a sprinkler head assembly and includes a plurality of arched feet which allow the base to be disposed directly over the water supply pipes of the irrigation system. The base also includes a plurality of fin-like protrusions disposed on an outer surface thereof to prevent the base from moving or rotating out of position once installed in the ground.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a front perspective view of the universal sprinkler housing of the present invention including a sprinkler head assembly mounted therein;

FIG. 2 is an exploded view of the universal sprinkler housing of FIG. 1;

FIG. 3 is an exploded sectional view of the universal sprinkler housing taken along line III-III of FIG. 2;

FIG. 4 is a top view of the upper member of FIG. 2;

FIG. 5 is a cross-sectional view of the upper member with an insertion/removal tool inserted therein; and

FIG. 6 is a cross-sectional view of a base of the universal sprinkler guard according to a second embodiment.

### DETAILED DESCIPTION OF PREFERRED EMBODIMENTS

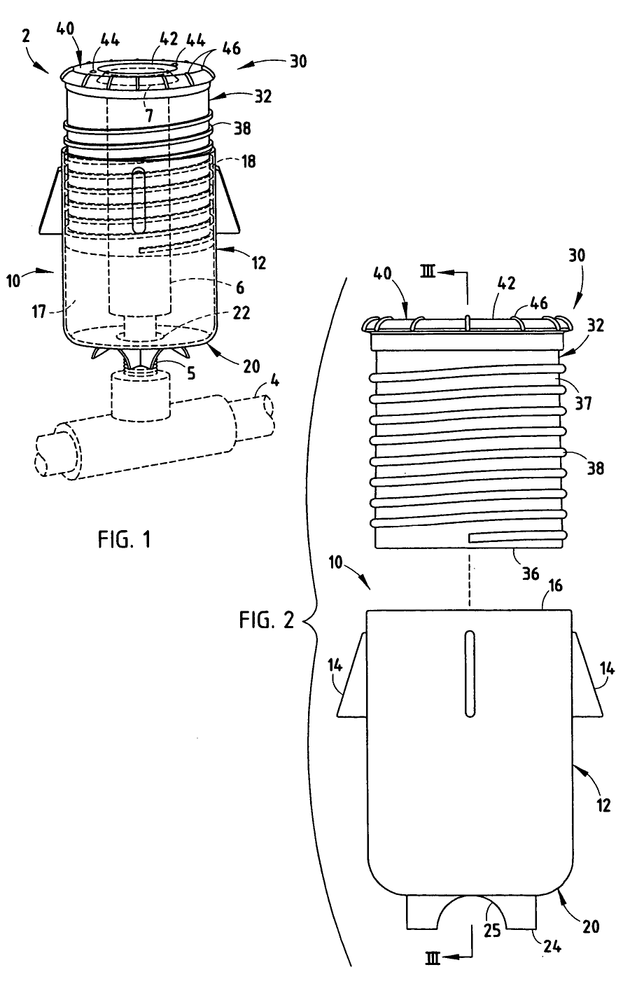

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

As best illustrated by FIGS. 1 and 2, a first embodiment of a universal sprinkler housing 2 includes a base member 10 and an upper member 30. Base member 10 has a thread 18 disposed on an interior surface of body 12 while upper housing 30 has a thread 38 disposed on the exterior surface of body 32. Base and upper members 10 and 30, respectively, are adjustably interconnected by threadingly engaging external threads 38 of upper member 30 to or within external threads 18 of base member 10. The threaded engagement allows upper member 30 to be adjustable in height with respect to base member 10. The adjustability allows housing 2 to accommodate and protect a variety of sizes of sprinkler head assemblies making it a universal housing which can protect most commercially available pop-up type sprinkler head assemblies.

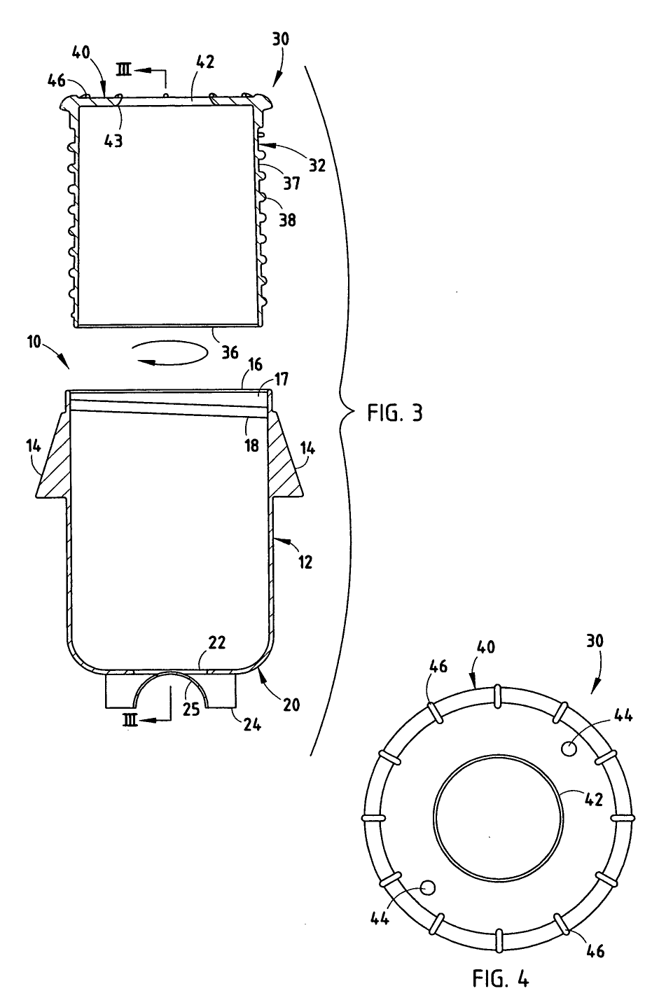

As shown in FIG. 3, base member 10 includes a generally cylindrical tubular body 12 including a plurality of fins 14 disposed along the periphery thereof. Body 12 further includes an open top 16 and an inside surface 17. Inside surface 17 of body 12 has thread 18 disposed thereon. In a preferred embodiment, thread 18 is a relatively large external thread comprising 0.5 threads per inch (threads/inch) and includes approximately single revolution. The relatively large pitch of thread 18, along with its external configuration (the threads protrude from the surface), allows thread 18 to be engaged with external thread 38 of upper member 30. The large thread pitch and the external nature of both threads 38 and 18 allow base member 10 and upper member 30 to be threadingly engaged even when dirt and small particles are disposed between the threads. To wit, the threads of the present invention function, that is say rotate, even in the presence of dirt and small particles that can prevent ordinary threads from functioning. The preferred thread size ranges from about 0.1 threads/inch to about 8 threads/inch, more preferably from about 0.25 threads/inch to about 0.75 threads/inch and most preferably from about 0.4 threads/inch to about 0.6 threads/inch. As used herein, the terminology “relatively large threads” is meant to encompass the widest of the above described ranges. Of course, thread 18, as well as associated thread 38 discussed below, may be either an external thread or an internal thread and further, may be greater than or less than the specified ranges, as the specific requirements dictate.

Opposite open top 16 is bottom 20 which includes an aperture 22 for receiving the riser 5 of an underground sprinkler system therethrough (FIG. 1). Additionally, bottom 20 includes a plurality of feet 24 each having a semi-spherical arch 25. Feet 24, and more particularly arches 25, are designed to fit over or otherwise accommodate supply lines 4 of an underground type irrigation system.

With respect to FIG. 1, aperture 22 of base 10 is sized so as to accommodate riser 5 such that the riser extends through aperture 22 without being affixed or otherwise secured thereto. In this embodiment the riser is free to “float” or move within aperture 22 and therefore, any unwanted forces that are transmitted to housing 2 will be transferred to feet 24 rather than subjecting the riser to the transmitted force. However, in an alternative embodiment, aperture 22 may be sized such that base member 10 is trapped or otherwise secured between the bottom of the sprinkler head assembly and the riser once the sprinkler head assembly and the riser are secured to each other.

Base member 10 may be fabricated from numerous materials. Generally, a semi-rigid or rigid material can be used such that base member 10 is capable of withstanding the elements that an underground irrigation system would be subjected to. Such materials are commonly known within the art and may include, but are not limited to thermo-plastics, thermo-sets and elastomers. In a preferred embodiment, Acrylonitrile Butadiene Styrene (ABS) is used. Such an ABS is available from Calsak Polymers as PA764B. Although molding compounds have been specifically mentioned, the method of fabricating base 10 is not critical to the inventive concept and although the preferred embodiment is molded, this is not meant to be limiting in any manner and base 10 may be fabricated from any known method, including machining, 3-D layering and the like.

As illustrated in FIG. 3, upper member 30 includes a generally cylindrical tubular body 32 comprising an open bottom 36 and a top 40. Body 32 has an outside surface 37 with a thread 38 disposed thereon. Thread 38 is designed to match the corresponding thread 18 on base member 10. In a preferred embodiment, thread 38 is a relatively large external thread comprising 0.5 threads per inch. Additionally, thread 38 is disposed over a substantial portion of outside surface 37 and in the preferred embodiment, thread 38 traverses from 50% to 100% of the longitudinal length of upper member 30.

As best illustrated by FIG. 4, top 40 includes an aperture 42 and a plurality of smaller apertures 44. With reference to FIG. 3, aperture 42 includes a chamfer 43 disposed along the periphery thereof. Chamfer 43 aids with the centering of a sprinkler head assembly to ensuring the sprinkler head itself will be disposed centrally with respect to a longitudinal axis of upper member 30. This centering is accomplished because chamfer 43 acts as a ramp and will tend to re-center or force an otherwise off-center sprinkler head, when at least part of the sprinkler head is disposed within the chamfer, to the center of aperture 42. This positioning ensures that the pop-up head of the sprinkler assembly will protrude from aperture 42 when the irrigation system is charged. On the other hand, this central positioning also ensures that the pop-up head will be capable of fully retracting into the sprinkler head assembly when the system is discharged. That is to say, the pop-up sprinkler head is disposed within aperture 42 via chamfer 43 such that it is capable of freely extending and retracting through aperture 42.

As noted above and with respect to FIG. 4, top 40 also includes a plurality of apertures 44. Although illustrated as circular, apertures 44 may take the form of various shapes and sizes. In the preferred embodiment these apertures are circular in geometry and are used to aide in the insertion, removal and rotation of upper member 30 into, out-of or within base member 10. This may be accomplished, for example, by the use of a tool 50 (FIG. 5) having at least a pair of outstanding legs 51 which are inserted through apertures 44, thereby allowing a handle 52 to be used to turn or otherwise urge upper member 30 either into or out of base member 10. Top 40 also includes a plurality of ridges, protrusions or ribs 46.

Ribs 46 are disposed along the peripheral edge of top 40 to assist in gripping upper member 30 thereby aiding with the insertion, removal or adjustment of upper member 30 into or out of base member 10. Ribs 46 work especially well when upper member 30 is wet, for example due to the discharge of the irrigation system, and provide a gripping feature which significantly adds to the ability of a user to grip upper member 30 when adjusting or otherwise turning upper member 30.

Upper member 30 may also be fabricated from numerous materials and generally, any semi-rigid or rigid material can be used such that upper member 30 is capable of withstanding the elements that an underground irrigation system would be subjected to. Further, upper member 30 may be fabricated from the same material as base member 10 or a different material depending on the specific requirements. However, in the preferred embodiment upper member 30 is fabricated from the same material as base member 10 as discussed previously. Of course, the method of fabricating upper member 30 is not critical to the inventive concept and, as with base member 10, the preferred embodiment is molded.

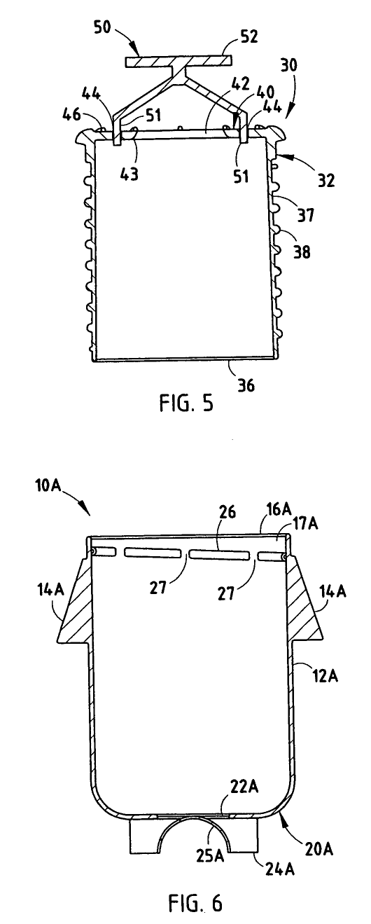

The reference numeral 10A (FIG. 6) generally designates another embodiment of the present invention having a non-continuous or interrupted external thread 26. Since lower housing 10A is similar to the previously described housing 10, similar parts appearing in FIGS. 1-5 and FIG. 6, respectively, are represented by the same, corresponding reference numeral, except for the suffix “A” in the numerals of the latter. In lower housing 10A, external thread 26 comprises a plurality of interruptions 27. Interruptions 27 include a plurality of spaces, each space including a lack of threaded material, disposed along the thread path. Interruptions 27 are spaced and sized to be wide enough to allow dirt, small rocks or other particles which have entered universal sprinkler housing 2A to pass therethrough while ensuring that threads 26 and 38 remain threadably engageable. In a preferred embodiment, external thread 26 comprises 0.5 threads per inch and has a plurality of interruptions therebetween. The preferred embodiment utilizes 7 interruptions 27 each of about 0.195 inches. Additionally, these interruptions may be disposed on external thread 38A (not shown) of upper member 30A, either alone or in combination with interruptions 27 of base member threads 26. The preferred embodiment utilizes external threads on an inside surface 17A of base member 10A and an outside surface 37A of upper member 30A.

As best seen in FIG. 1, the preferred embodiment of the universal sprinkler guard is used by first installing lower housing 10 such that feet 24, or more particularly semi-spherical arches 25, reside on or over supply pipe 4. In the preferred embodiment, lower housing 10 will have four feet including four semi-spherical arches allowing the lower housing to be positioned over up to four supply pipes simultaneously. Therefore, lower housing 10 may be used and feet 24 may reside over up to a four-way junction of supply pipe. Riser assembly 5 is disposed through aperture 22, and sprinkler head assembly 6 is then positioned within inside surface 17 of body 12, wherein sprinkler head assembly 6 is affixed or otherwise connected to riser assembly 5. Typically, sprinkler head assembly 6 is threadingly engaged with riser assembly 5. In one embodiment, sprinkler head 6 is threaded onto riser assembly 5 thereby firmly securing base member 10 between the threaded engagement of riser assembly 5 and sprinkler head 6 (not shown). However, in the preferred embodiment, aperture 22 is large enough to allow riser 5 to pass therethrough such that it is not affixed or otherwise captured between riser assembly 5 and the base of sprinkler head assembly 6, thereby allowing any downward forces to be transferred to feet 24 without subjecting riser assembly 5 to the aforementioned forces.

Upon installation of lower housing 10 onto or over riser assembly 5 and after engagement of sprinkler head assembly 6, upper member 30 is threadingly engaged to base member 10 via threads 38 and 18, respectively. During this engagement, fins 14 protruding from body 12 prevent body 12 from rotating within the ground and ensure that lower housing 10 remains in the original position it was installed in. Upper member 30 is then turned in a direction which further engages upper member 30 within base member 10 thereby bringing top 40 into contact with sprinkler head 7 of sprinkler head assembly 6. This engagement is further facilitated by chamfer 43 (FIG. 3) of aperture 42 such that if sprinkler head 7 is off center, chamfer 43 acts to re-center the sprinkler head. Chamfer 43 ensures that the top of the sprinkler head is correctly positioned within aperture 42, thereby allowing the sprinkler head to fully and without interruption extend when the sprinkler assembly is charged, thereby effectuating watering or irrigation.

The assembly, disassembly and adjustment of universal housing 2 is inventively aided though the use of tool 50 whereby legs 51 may be inserted through apertures 44 of top 40 thereby aiding the turning or rotation of the upper member with respect to the base member through handle 52. This rotation is further aided by the addition of ribs 46 disposed along the periphery of top 40. These ribs allow a user to better grip top 40 and prevent the users hands from slipping when turning upper member 30. For example when top 40 is wet, as it will be shortly after the system has been in use, ribs 46 allow upper member 30 to be adjusted with less effort. This is in great part because more friction or torque can be exerted on the upper member due to the presence of ribs 46. Therefore, through apertures 44, tool 50 and ribs 46, upper member 30 may be adjusted relatively effortlessly.

In various preferred aspects of the present invention, a novel universal housing prevents shocks or other disturbances from lawn equipment, vehicles, people, and the like from reaching the sprinkler assembly and associated riser. This is accomplished by directing the applied forces through the upper housing, to the lower housing and ultimately to the feet. In addition, if such an applied force is not great enough to damage the sprinkler assembly or the riser, it may render the sprinkler assembly out of adjustment. The universal housing of the present invention also prevents these lower level forces from affecting the settings of the original configuration, thereby preventing time consuming and/or costly repairs.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A universal sprinkler housing for underground type irrigation systems comprising:
a base member, said base member adapted to receive a pop-up style sprinkler assembly; and
an upper member, said upper member threadably engaged to said base member, whereby said base member and said upper member are adjustable in height with respect to one another to fully enclose a variety of sizes of pop-up style sprinkler assemblies.

2. The housing of claim 1, wherein:
said upper member includes a thread disposed on an outside surface of said upper member; and
said bottom member includes a thread disposed on an inside surface of said bottom member.

3. The housing of claim 2, wherein:
said threads disposed on said upper member and said bottom member include a relatively large thread pitch, whereby dirt and small particles that may enter the sprinkler housing do not prevent said upper thread from rotating within said lower thread.

4. The housing of claim 2, wherein:
said threads disposed on said upper member and said bottom member include a 0.5 inch thread pitch.

5. The housing of claim 1, wherein:
said upper member comprises a thread disposed longitudinally along a substantial portion the outside surface of said upper member.

6. The housing of claim 1, wherein:
said upper member comprises a thread disposed longitudinally along at least 25 percent of the outside surface of said upper member.

7. The housing of claim 1, wherein:
said upper member includes a plurality of ribs disposed generally along a periphery of a top thereof.

8. The housing of claim 1, wherein:
said upper member includes a top, said top comprising an aperture sized to allow a sprinkler head of a pop-up style sprinkler assembly to pass therethrough when said sprinkler assembly is activated and deactivated; and
said top aperture includes a tapered inside edge, whereby an off-center sprinkler assembly is centered by said tapered edge when said top is installed over said sprinkler head.

9. The housing of claim 8, wherein:
said top member includes a plurality of apertures adapted for engagement with a tool, said tool having a plurality of legs adapted for insertion through said apertures;
wherein when said legs are inserted through said apertures, said tool may be used to rotate said upper member.

10. The housing of claim 1, wherein:
said base member is tubular-shaped having an inside surface, an open top, a bottom including an aperture, and a thread disposed on the inside surface between said top and said bottom.

11. The housing of claim 1, wherein:
said base member includes at least one fin disposed on an exterior surface thereof.

12. The housing of claim 1, wherein:
said base member includes a partially closed bottom, said bottom including an aperture for receiving a stem of an underground sprinkler system therethrough.

13. The housing of claim 1, wherein:
said base member includes at least two arched feet disposed on an outside bottom surface thereof, said arched feet sized to fit over a supply line of an underground type irrigation system.

14. A universal sprinkler housing for underground type irrigation systems comprising:
a base member, said base member adapted to receive a pop-up style sprinkler assembly; and
an upper member, said upper member adapted to be threadably engaged to said base member, whereby said base member and said upper member are adjustable in height with respect to one another to fully enclose a variety of sizes of pop-up style sprinkler assemblies.

15. The housing of claim 14, wherein:
said upper member includes a thread disposed on an outside surface of said upper member; and
said bottom member includes a thread disposed on an inside surface of said bottom member.

16. The housing of claim 15, wherein:
said threads disposed on said upper member and said bottom member include a relatively large thread pitch, whereby dirt and small particles that may enter the sprinkler housing do not prevent said upper thread from rotating within said lower thread.

17. The housing of claim 15, wherein:
said threads disposed on said upper member and said bottom member include a 0.5 inch thread pitch.

18. The housing of claim 14, wherein:
said upper member comprises a thread disposed longitudinally along a substantial portion the outside surface of said upper member.

19. The housing of claim 14, wherein:
said upper member comprises a thread disposed longitudinally along at least 25 percent of the outside surface of said upper member.

20. The housing of claim 14, wherein:
said upper member includes a plurality of ribs disposed generally along a periphery of a top thereof.

21. The housing of claim 14, wherein:
said upper member includes a top, said top comprising an aperture sized to allow a sprinkler head of a pop-up style sprinkler assembly to pass therethrough when said sprinkler assembly is activated and deactivated; and
said top aperture includes a tapered inside edge, whereby an off-center sprinkler assembly is centered by said tapered edge when said top is installed over said sprinkler head.

22. The housing of claim 21, wherein:
said top member includes a plurality of apertures adapted for engagement with a tool, said tool having a plurality of legs adapted for insertion through said apertures;
wherein when said legs are inserted through said apertures, said tool may be used to rotate said upper member.

23. The housing of claim 14, wherein:
said base member is tubular-shaped having an inside surface, an open top, a bottom including an aperture, and a thread disposed on the inside surface between said top and said bottom.

24. The housing of claim 14, wherein:
said base member includes at least one fin disposed on an exterior surface thereof.

25. The housing of claim 14, wherein:
said base member includes a partially closed bottom, said bottom including an aperture for receiving a stem of an underground sprinkler system therethrough.

26. The housing of claim 14, wherein:
said base member includes at least two arched feet disposed on an outside bottom surface thereof, said arched feet sized to fit over a supply line of an underground type irrigation system.

27. A universal sprinkler guard for underground type irrigation systems comprising:
a base member adapted to receive a pop-up style sprinkler assembly, said base member including a threaded surface;
an upper member including a threaded surface;
said base member and said upper members threadably engaged; and
at least one threaded surface of said base member and said upper member including a notched thread whereby dirt and particles that may enter the threaded engagement are removed therefrom such that dirt and small particles do not prevent said upper thread from rotating within said lower thread.

28. The housing of claim 27, wherein:
said upper member thread is disposed on an outside surface of said upper member; and
said bottom member thread is disposed on an inside surface of said bottom member.

29. The housing of claim 27, wherein:
said threads disposed on said upper member and said bottom member include a relatively large thread pitch, whereby dirt and small particles that may enter the sprinkler housing do not prevent said upper thread from rotating within said lower thread.

30. The housing of claim 27, wherein:
said threads disposed on said upper member and said bottom member include a 0.5 inch thread pitch.

31. The housing of claim 27, wherein:
said upper member comprises a thread disposed longitudinally along a substantial portion the outside surface of said upper member.

32. The housing of claim 27, wherein:
said upper member comprises a thread disposed longitudinally along at least 25 percent of the outside surface of said upper member.

33. The housing of claim 32, wherein:
said upper member includes a plurality of ribs disposed generally along a periphery of a top thereof.

34. The housing of claim 32, wherein:
said upper member includes a top, said top comprising an aperture sized to allow a sprinkler head of a pop-up style sprinkler assembly to pass therethrough when said sprinkler assembly is activated and deactivated; and
said top aperture includes a tapered inside edge, whereby an off-center sprinkler assembly is centered by said tapered edge when said top is installed over said sprinkler head.

35. The housing of claim 34, wherein:
said top member includes a plurality of apertures adapted for engagement with a tool, said tool having a plurality of legs adapted for insertion through said apertures;
wherein when said legs are inserted through said apertures, said tool may be used to rotate said upper member.

36. The housing of claim 32, wherein:
said base member is tubular-shaped having an inside surface, an open top, a bottom including an aperture, and a thread disposed on the inside surface between said top and said bottom.

37. The housing of claim 32, wherein:
said base member includes at least one fin disposed on an exterior surface thereof.

38. The housing of claim 32, wherein:
said base member includes a partially closed bottom, said bottom including an aperture for receiving a stem of an underground sprinkler system therethrough.

39. The housing of claim 32, wherein:
said base member includes at least two arched feet disposed on an outside bottom surface thereof, said arched feet sized to fit over a supply line of an underground type irrigation system.

40. A universal sprinkler guard for underground type irrigation systems comprising:
a base member adapted to receive a pop-up style sprinkler assembly;
an upper member, said upper member including a top surface, said top surface including a plurality of ribs disposed along the periphery thereof defining a gripping area;
said base and upper members threadably adjustably engaged;
wherein said base and said upper members are adjustable in height with respect to one another to fully enclose a variety of sizes of pop-up style sprinkler assemblies.

41. The housing of claim 40, wherein:
said upper member includes a thread disposed on an outside surface of said upper member; and
said bottom member includes a thread disposed on an inside surface of said bottom member.

42. The housing of claim 41, wherein:
said threads disposed on said upper member and said bottom member include a relatively large thread pitch, whereby dirt and small particles that may enter the sprinkler housing do not prevent said upper thread from rotating within said lower thread.

43. The housing of claim 40, wherein:
said threads disposed on said upper member and said bottom member include a 0.5 inch thread pitch.

44. The housing of claim 40, wherein:
said upper member comprises a thread disposed longitudinally along a substantial portion the outside surface of said upper member.

46-64. (canceled)

65. The housing of claim 40, wherein:
said upper member comprises a thread disposed longitudinally along at least 25 percent of the outside surface of said upper member.

66. The housing of claim 40, wherein:
said top surface comprises an aperture sized to allow a sprinkler head of a pop-up style sprinkler assembly to pass therethrough when said sprinkler assembly is activated and deactivated; and
said top aperture includes a tapered inside edge, whereby an off-center sprinkler assembly is centered by said tapered edge when said top is installed over said sprinkler head.

67. The housing of claim 40, wherein:
said top surface includes a plurality of apertures adapted for engagement with a tool, said tool having a plurality of legs adapted for insertion through said apertures;
wherein when said legs are inserted through said apertures, said tool may be used to rotate said upper member.

68. The housing of claim 40, wherein:
said base member is tubular-shaped having an inside surface, an open top, a bottom including an aperture, and a thread disposed on the inside surface between said top and said bottom.

69. The housing of claim 40, wherein:
said base member includes at least one fin disposed on an exterior surface thereof.

70. The housing of claim 40, wherein:
said base member includes a partially closed bottom, said bottom including an aperture for receiving a stem of an underground sprinkler system therethrough.

71. The housing of claim 40, wherein:
said base member includes at least two arched feet disposed on an outside bottom surface thereof, said arched feet sized to fit over a supply line of an underground type irrigation system.

72. A universal sprinkler guard for underground type irrigation systems comprising:
a base member adapted to receive a pop-up style sprinkler assembly;
an upper member, said upper member including a plurality of apertures adapted for engagement with a tool, said tool having a plurality of legs adapted for insertion though said apertures;
said base member and said upper member threadably adjustably engaged;
wherein when said legs are inserted through said apertures, said tool may be used to rotate said upper member;
wherein further said base and said upper members are adjustable in height with respect to one another to fully enclose a variety of sizes of pop-up style sprinkler assemblies.

73. The housing of claim 72, wherein:
said upper member includes a thread disposed on an outside surface of said upper member; and
said bottom member includes a thread disposed on an inside surface of said bottom member.

74. The housing of claim 73, wherein:
said threads disposed on said upper member and said bottom member include a relatively large thread pitch, whereby dirt and small particles that may enter the sprinkler housing do not prevent said upper thread from rotating within said lower thread.

75. The housing of claim 73, wherein:
said threads disposed on said upper member and said bottom member include a 0.5 inch thread pitch.

76. The housing of claim 72, wherein:
said upper member comprises a thread disposed longitudinally along a substantial portion the outside surface of said upper member.

77. The housing of claim 72, wherein:
said upper member comprises a thread disposed longitudinally along at least 25 percent of the outside surface of said upper member.

78. The housing of claim 72, wherein:
said upper member includes a plurality of ribs disposed generally along a periphery of a top thereof.

79. The housing of claim 72, wherein:
said upper member includes a top, said top comprising an aperture sized to allow a sprinkler head of a pop-up style sprinkler assembly to pass therethrough when said sprinkler assembly is activated and deactivated; and
said top aperture includes a tapered inside edge, whereby an off-center sprinkler assembly is centered by said tapered edge when said top is installed over said sprinkler head.

80. The housing of claim 72, wherein:
said base member is tubular-shaped having an inside surface, an open top, a bottom including an aperture, and a thread disposed on the inside surface between said top and said bottom.

81. The housing of claim 72, wherein:
said base member includes at least one fin disposed on an exterior surface thereof.

82. The housing of claim 72, wherein:
said base member includes a partially closed bottom, said bottom including an aperture for receiving a stem of an underground sprinkler system therethrough.

83. The housing of claim 72, wherein:
said base member includes at least two arched feet disposed on an outside bottom surface thereof, said arched feet sized to fit over a supply line of an underground type irrigation system.
